(19) United States
(12) Patent Application Publication
(10) Pub. No.: US 2024/0328781 A1
(43) Pub. Date: Oct. 3, 2024

(54) CURVATURE CORRECTION

(71) Applicant: TeraView Limited, Cambridge, Cambridgeshire (GB)

(72) Inventors: Ian Alasdair Pentland, Cambridge (GB); Alessia Portieri, Cambridge (GB); Philip Francis Taday, Cambridge (GB); Bryan Edward Cole, Cambridge (GB); Donald Dominic Arnone, Cambridge (GB)

(73) Assignee: TeraView Limited, Cambridge, Cambridgeshire (GB)

(21) Appl. No.: 18/698,644

(22) PCT Filed: Oct. 4, 2022
(86) PCT No.: PCT/GB2022/052510

§ 371 Date: Apr. 4, 2024

(30) Foreign Application Priority Data
Oct. 4, 2021 (GB) 2114195.7

(51) Int. Cl. G01B 21/04; G01B 11/06; G01B 11/24; G01N 21/3581

(52) U.S. Cl. CPC G01B 21/045; G01B 11/0625; G01B 11/24; G01N 21/3581

(57) ABSTRACT

A method and apparatus is provided for determining the thickness of coating layers of a curved surface when examining the surface with terahertz radiation. The method involves measuring detected reflected radiation and applies a correction factor to obtain the thicknesses of the layers. This addresses the problem of compensating for the curvature of the surface when determining coating thickness.

### FIELD

Embodiments of the present invention relate to the field of measuring coatings on curved surfaces using terahertz radiation.

### BACKGROUND

Terahertz radiation is a non-invasive method of determining the internal structure of an object and the thickness of its layers.

For a coated object consisting of multiple coatings and a substrate, the thickness of the coating layer can be determined in reflection geometry by using time of flight measurements. For instance, for a Terahertz pulse, the delay in the emitted Terahertz pulse reflected from the multiple coatings is measured. The time delay of the reflected pulse as it passes through the layers is used to determine a thickness of the layer using a refractive index of said layer. See, for instance, GB 2559164 A.

However, where an object is curved such that a curved surface is formed, the curvature results in the position of the surface varying relative to the Terahertz emitter as the Terahertz spot extends across the curved surface of the object. Therefore, the time of flight considers the thickness of the layer as well as the varying surface of the curvature.

The problem of compensating for the curvature of the surface is made difficult in Terahertz determinations of thickness coatings because the Terahertz spot size varies for different frequencies of Terahertz radiation. Therefore, each frequency is affected differently by the curvature with varying time delays depending on the curvature and the spot size, along with other variations such as the material of the object or the distinction between the coating layers.

The present invention addresses these problems and reduces errors associated with the determination of coating thickness using Terahertz radiation for curved surfaces.

### SUMMARY

In accordance with an aspect of the invention, there is provided a method for determining the thickness of a plurality of coating layers on a curved surface of a sample, the method comprising:
measuring a curvature of the sample, irradiating the said sample with THz radiation, said THz radiation comprising a plurality of frequencies in the range from 0.01 THz to 10 THz;
detecting the reflected radiation to produce a sample response said sample response being derived from the reflected radiation;
referring to a profile library containing at least one profile library sample to obtain a correction factor based on the curvature of the sample;
applying the correction factor to the sample response to obtain a corrected reflection;
outputting the thicknesses of the layers using the corrected reflection.

The above embodiment addresses the problem of a curved surface that affects the detected reflected radiation. In particular, the information from the detected radiation varies due to the coating of the surface and the curvature of the surface. Therefore, to address this, a correction factor is applied to produce a corrected reflection based on the curvature of the sample, which is used to calculate the coating thickness in the detected radiation. The correction factor is based on a profile library that comprises at least one profile library sample. The curvature of the measured sample is compared to the profile library to obtain a correction value. The corrected reflection is then the resultant reflection without any curvature component in the information. Therefore, this corrected value can be used to calculate the thickness.

Preferably, the at least one profile library sample has a curvature similar to the sample. A profile library contains samples for surfaces with varying curvatures. In order to ensure a correct correction factor, the profile of the sample, i.e. the curvature given a width or length of the sample or the positional coordinates of the sample, should be similar to that of at least one of the profile library curvatures.

Preferably, for a plurality of profile library samples forming a range of curvatures, the range of curvatures are for interpolation or extrapolation to obtain a resultant curvature, the resultant curvature being similar to the sample. Whilst a similar profile is preferred, a given profile library where there are a plurality of different curvature profiles can be used where the sample sits within this range. The range of data can be interpolated to provide an equivalent profile of the sample of interest. In some situations, the data can be extrapolated to obtain an equivalent profile of the sample of interest when the sample sits outside the range.

Preferably, the correction factor is obtained from the comparison of the parameters of the profile library samples to the parameters of a nominal profile library sample. For a given curvature profile the parameters, i.e. measurements from the reflection, contain a component of the curvature itself. Therefore, in the profile library sample, each of the profile library sample parameters can be compared to a nominal profile library sample for a nominal profile. This provides a correction factor that can be applied to the sample of a given curvature that is being measured.

Preferably, the profile library samples have a structure the same as that of said sample. Where the structure, such as the order of materials, material types, etc. is similar for the examples in the library and for the sample, this can assist in increasing the accuracy of the output data. In some situations, a different structure can be used. More specifically, a single material structure can be used, e.g. metal, that will provide a set of data without variations due to the material used.

Preferably, the profile library contains the magnitude and phase of the waveform for reflected radiation for the profile library samples. Various details can be recorded for the profile library samples. In one case, for the reflected THz radiation, the magnitude and phase is recorded to form the dataset. This can be obtained by irradiating profile library samples and using the measurements to form a data set. These can be across the range of frequencies of THz radiation. Alternatively, the profile library may be constructed from other data means, such as theoretical calculations for samples instead of irradiating physical samples. Different measured parameters of the profile library samples can be recorded.

Preferably, a magnitude error and a phase error is calculated as a function of frequency for the plurality of frequencies, for example across the 0.01 THz to 10 THz range. The correction factor can be interpolated for the measured curvature of the sample. Where an error correction due to the curvature is calculated, this will be across the frequency range to ensure that a pulse or continuous wave of THz radiation can be used on a sample to detect all the layers. The measured curvature of the sample may not align directly with the curvatures in the reference library. Therefore, from the correction factors for the different curvatures, the required curvature is either selected from an appropriate profile library sample, or is interpolated between the points in the library. This allows the error terms to be generalised for any given curvature profile. As discussed above, where the profile of the sample is not within the range of the profile library, data can also be extrapolated.

Preferably, the magnitude error and phase error are calculated using a polynomial fit for each profile library sample. Various techniques can be used for providing error terms to result in generalised fit. Using polynomial regression, any measured curvature can be used to satisfy the equation to result in a correction value.

Preferably, a profile is measured using the curvature that is a single value parameter. A profile of the curvature can be defined in a number of ways, such as a set of coordinates. In order to better utilize the measure curvature and thus profile, and allow it to be used as a parameter to correct the THz reflection, it is preferred that the profile is defined as a single value parameter. For instance, where the profile library samples have some symmetry, this will allow a single parameter to be used in such situations. This, for instance, can then be used as an axis in the THz correction. Therefore, this can provide a more straightforward means of applying a correction value.

Preferably, the library profile samples are uncoated. This ensures that the profile library sample does not include any additional parameters, such as layers, that would affect the measurement other than the curvature. This ensures that the data is normalised in the profile library by removing instrumental effects that could affect sample and profile measurements. Therefore, a more accurate thickness calculation can be obtained.

Preferably, the library profile samples are coated with a highly reflective layer. A highly reflective layer is one in which the reflectivity is close 1.0, i.e. the radiation is fully or almost fully reflected. Therefore, there is no compensation needed to account for the measured data not reflecting all of the THz radiation. This provides a more accurate means of measuring the thickness, as the profile library will have less interference in the recorded data to account for curvature. More preferably, the profile library samples are coated with gold. Gold has a very high reflectivity. In some embodiments, the reflective material does not need to be a coating, but instead the profile library samples can be formed of the reflective material.

Preferably, a time delay of detecting the reflected radiation is measured to output the thickness of the layers. The reflected radiation from the sample has an expected time to be reflected. Where there is a delay, this can be used to calculate the layer thickness. As discussed above, in the situation where there is a curvature, this can also affect the time delay in the reflected radiation. Therefore, this is corrected with the correction factor.

Preferably, a refractive index for each of the plurality of layers is used to output the thickness of the at least one layer. Different coatings and materials, e.g. of the sample, have different refractive indexes. Therefore, when measuring the reflected radiation, such as across a wavelength, if it is known that the refractive index is related to a certain coating or material this better ensures that the thickness of the layer of a coating or plurality of coatings can be calculated.

Preferably, the method includes selecting a preferred refractive index value or model from data from a set of calibration samples. For instance, the set of calibration samples may be samples with a substrate and a single coating layer or/and a plurality of coating layers. This allows the refractive index to be determined for known coatings. Therefore, when measuring a sample to determine a coating thickness, the coatings can also be determined, i.e. from the wavelength of the THz radiation reflected.

Preferably, the curvature is measured using a laser gauge. By using a different means of measuring curvature than the THz radiation, it can be ensured that the data obtained from the reflection is used for the calculation of the thickness only.

In a further aspect of the invention, there is provided a system for determining the thickness of a plurality of coating layers on a curved surface of a sample, the system comprising:
a sensor, said sensor comprising a source of THz radiation for irradiating the said sample with THz radiation in a plurality of frequencies in the range from 0.01 THz to 10 THz;
a detector for detecting the reflected radiation to produce a sample response said sample response being derived from the reflected radiation;
the system further comprising an analysis unit, said analysis unit comprising a processor and a memory, said processor being adapted to:

access a profile library containing at least one profile library sample to obtain a correction factor based on a measured curvature of the sample;
apply the correction factor to the sample response to obtain a corrected reflection;
calculate the thicknesses of the layers using the corrected reflection.

This provides a system for the measurement of the thickness of a sample, where that sample has a curvature. The reflected THz radiation can be used to derive a thickness of a coating layer, e.g. as a result of the time for the given wavelength to be reflected. However, the curvature can also impact this reflection. Therefore, a correction factor can be applied to compensate for the curvature, allowing the coating layer thickness to be calculated.

In a further embodiment the reflected radiation, i.e. waveform is measured using a sensor. The method preferably further comprises positioning the sensor at a distance from the plurality of layers to allow a measurement to be performed. The distance can be measured using a laser gauge or another gauge to determine the distance of the sensor. The sensor may also be aligned using an angular measuring gauge to determine if the angle of the sensor is sufficient to allow a measurement to be performed. The above are particularly useful if the sensor is handheld. Thus, in an embodiment, there is sensor position feedback through interrogation of signals from terahertz and additional sensors (e.g. ultrasound, laser gauge, vision system) to indicate to operator (or robot controller) when sensor-to-surface distance and orientation are acceptable for high quality data collection. In some embodiments, the sensor can be controlled robotically.

According to an aspect of the invention, there is provided a method for determining the thickness of a plurality of coating layers on a curved surface of a sample, the method comprising:
measuring a curvature of the sample,
irradiating the said sample with THz radiation, said THz radiation comprising a plurality of frequencies in the range from 0.01 THz to 10 THz;
detecting the reflected radiation to produce a sample response, said sample response being derived from the reflected radiation;
referring to a profile library containing at least one profile library sample to obtain error terms based on the curvature of the sample;
applying the error terms to the sample response to obtain a corrected reflection;
outputting the thicknesses of the layers using the corrected reflection.

The error terms may comprise a magnitude error and a phase error as a function of frequency, or the error terms may comprise a real component and an imaginary component as a function of frequency.

In a further aspect of the invention, there is provided a system for determining the thickness of a plurality of coating layers on a curved surface of a sample, the system comprising:
a sensor, said sensor comprising a source of THz radiation for irradiating the said sample with THz radiation in a plurality of frequencies in the range from 0.01 THz to 10 THz;
a detector for detecting the reflected radiation to produce a sample response said sample response being derived from the reflected radiation;
the system further comprising an analysis unit, said analysis unit comprising a processor and a memory, said processor being adapted to:
access a profile library containing at least one profile library sample to obtain error terms based on the curvature of the sample;
apply the error terms to the sample response to obtain a corrected reflection;
calculate the thicknesses of the layers using the corrected reflection.

The above THz radiation can be applied using pulses, such as a collimated beam of pulses, it is to be appreciated that the present invention may also be implemented using a continuous wave (CW) source. Continuous wave generation is described in detail in European patent number EP 1 269 156 B1.

### BRIEF DESCRIPTION OF DRAWINGS

Embodiments of the invention will now be described, by way of example, only with reference to the accompanying schematic drawings in which:

FIG. 1 is an overview of a general system in accordance with an embodiment of the Invention;

FIG. 2 is a schematic of a sensor performing a terahertz measurement and a coated sample;

FIGS. 3(a) and 3(b) show a trace of the time-domain waveform reflected from non-metal substrate with two coatings of different refractive index (n2>n1);

FIG. 4 shows a trace of the time-domain waveform reflected from a substrate with multiple coatings of different refractive index, and a bar chart showing the coating layers;

FIG. 5 is a flow diagram showing the basic steps for obtaining a thickness from a coated sample;

FIG. 6 is a schematic of a coated sample with a curved surface being irradiated with two wavelengths of THz radiation;

FIG. 7 is a schematic of a sensor performing a terahertz measurement for a sample with a curved surface;

FIG. 8 is a flow diagram showing the basic steps for obtaining a thickness from a coated sample with a curved surface; and

FIG. 9 is a flow diagram showing a process for obtaining a thickness from a coated sample with a curved surface.

### DETAILED DESCRIPTION

This invention focuses on a means of correcting errors in Terahertz measurements arising from the effects of curvature in a non-planar sample on thickness measurements and analysis derived from the Terahertz data. This invention applies to all surfaces, but in particular those where the curvature of the sample is liable to change over time, such as a coating on a malleable substrate (e.g. a coating on rubber or plastic) that can change over time or change across a sample. Therefore, the determination of coating thickness is of importance in such situations.

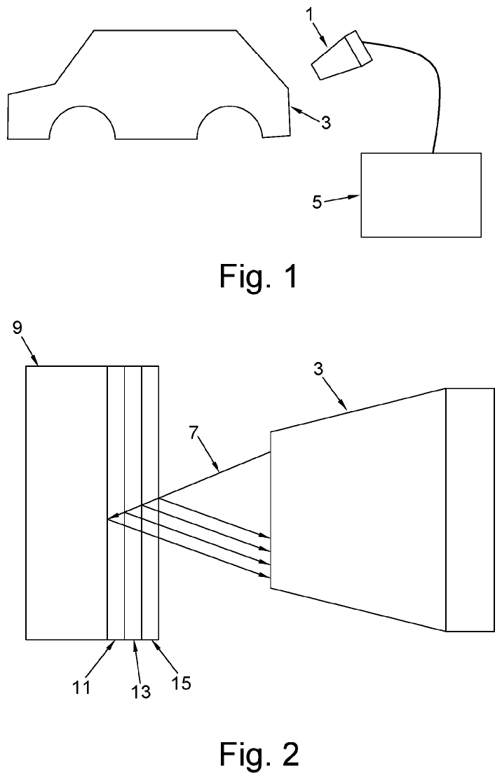

FIG. 1 shows a very basic overview of a system in accordance with an embodiment of the present invention. The system comprises a sensor 1 that will be described in more detail with reference to FIG. 2. In this embodiment, the sensor is a handheld 25 sensor which will be guided over the coated body of a vehicle 3 by a user (not shown).

FIG. 2 shows a simplified arrangement of the measurement that is made. The sensor 3 emits a broadband pulse of terahertz radiation 7 towards a panel 9 on the vehicle. The panel is a painted panel which has paint layers 11, 13 and 15. The terahertz radiation pulse will comprise a plurality of frequencies. For instance, the radiation will be in the range of 0.01 THz to 10 THz. However, in some embodiments, the range will be narrower, such as in the range from 0.06 THz to 4 THz. In this embodiment, three layers will be discussed. However, the method can be applied to any number of layers, from 2 upwards. Systems with 5 of more layers may be analysed.

Each layer has a boundary with the previous layer and this boundary will cause a partial reflection of some of the terahertz radiation. That is, the layers are semi-transparent to the terahertz signal. The terahertz signal reflected from each boundary will have experienced a slightly different optical path (due to the thickness and optical response of the layer through which it passed), namely, the time of flight of the signal reflector back to the detector is measured and therefore it is possible to determine the thickness of the layers accurately by the reflected terahertz signal for the given arrival times and thus delay of refection of the signal.

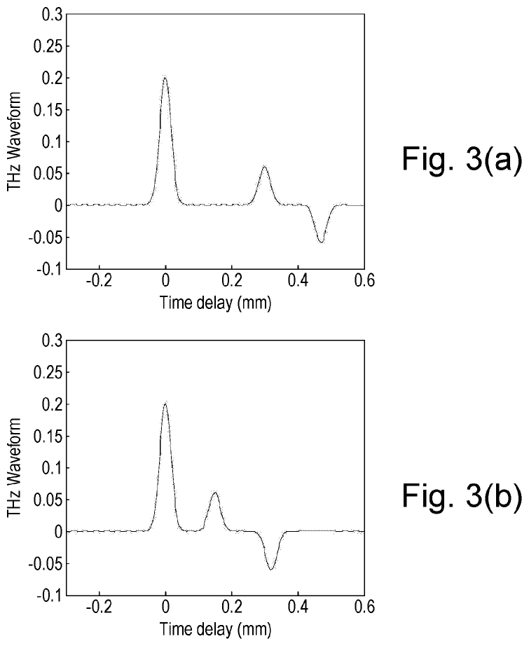

FIGS. 3(a) and 3(b) shows a trace of the time-domain waveform reflected from non-metal substrate with two coatings of different refractive index (n2>n1). In FIG. 3(a), the large thickness of coating 1 means reflection peak 1 (from air-surface interface) and reflection peak 2 (from interface between coatings 1 and 2) are easily distinguished. In FIG. 3(b) the reduced thickness of coating 1 results in a decreased separation between reflection peaks 1 and 2.

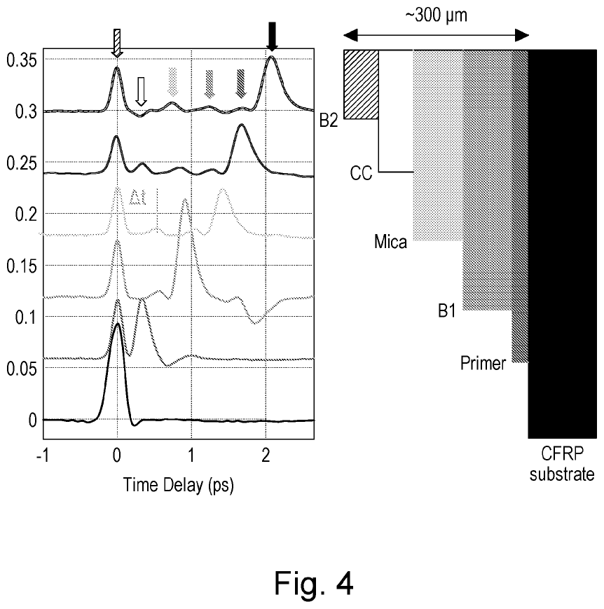

FIG. 4 shows an example trace of the time-domain waveform reflected for multiple coatings (five coatings and a substrate). This shown against a bar chart diagrammatically representing the thickness for each layer. The time delay of the reflection is given as the x axis to show the arrival time of the Terahertz signal at the detector after having been reflected at a layer.

The coating thickness di of each layer is calculated by using the peak separation for the time delay Δtᵢ and the n; refractive index of the coating. Wherein:

$${d}_{i} ∼ \frac{Δ {t}_{i}}{{n}_{i}} \qquad ( 1 )$$

Therefore, for a flat sample and for a given refractive index value of a layer, the arrival time of pulses (THz radiation) at the detector is determined by the thickness of the layer. Hence, the thickness di is the only factor (assuming a fixed refractive index nᵢ) that determines the measured pulse delay Δtᵢ.

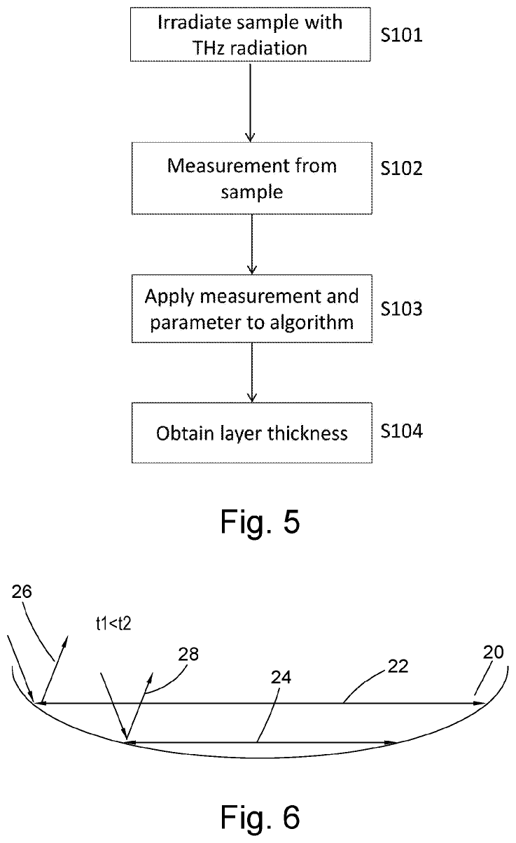

FIG. 5 shows a flowchart of the basic process which is used for determining the thickness of layers in a flat sample.

In step S101 the sample is irradiated with THz radiation. Terahertz radiation is emitted in a pulse or continuous wave form.

In step S102, the measurements from the sample are taken. The Terahertz is reflected from the sample to the detector, the emitter and detector often being part of the same sensor. The measurements are in the form of a sample response to the emitted THz radiation.

In step S103, the parameters applied to the measurement in an algorithm. As described above with reference to FIG. 4, this can be to use the time delay with the refractive index in equation (1).

In step S104, coating thickness is output from step S103. For a range of frequencies, this can provide a number of layer thicknesses for a given refractive index.

FIG. 6 shows a curved surface of interest 20. In this example, Terahertz radiation is applied at a first frequency and a second frequency, where the first frequency is lower than the second frequency. The size of the Terahertz spot, i.e. focal point of the radiation, will vary according to the frequency. For instance, a spot size at 0.5 THz could be around 5 mm and a spot size at 1 THz could be around 2.5 mm, according to the focal ratio of the optic used.

In FIG. 6, for the first frequency, the first spot 22 is larger than the second spot 24 for the second frequency. Therefore, a larger area is probed at the first frequency, as represented by the comparative sizes of the Terahertz spot 22, 24.

A first reflected THz pulse 26 for the first frequency is shown for the first spot 22. The flight time for the first reflected THz pulse 26 is t1. A second reflected THz pulse 28 for the second frequency is shown for the second spot 24. The flight time for the second reflected THz pulse is t2.

Given that the second Terahertz spot 24 is further away from the detector, the flight time will be longer. The size of the Terahertz spot and the curved surface 20 results in t1<t2 due to the curvature alone. Therefore, Δtᵢ is no longer determined by only the thickness of the coating, but also has an additional component of the delay by the position of the Terahertz spot on the curved surface 20 of the object.

The result is that the arrival time of the pulse at the detector will contain contributions from slower (t2) and faster (t1) components due to the curvature changes from the position of the reflection surface. This means that Δtᵢ will be modified to include curvature as well as coating contributions

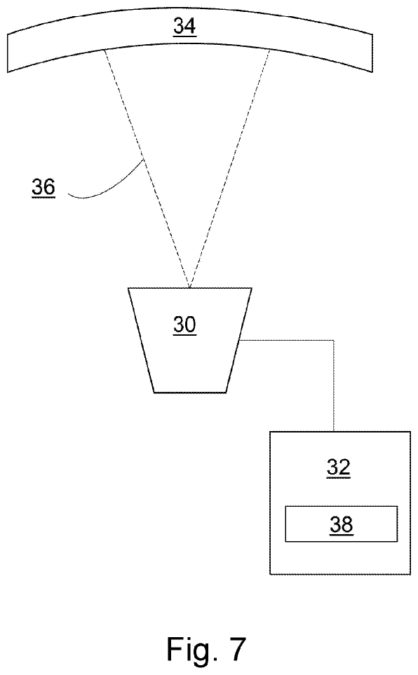

Referring to FIG. 7, there is provided a sensor 30 comprising a terahertz radiator emitter and detector. This emits a Terahertz signal/radiation 36, such as a Terahertz pulse 36 at a curved sample 34, the curved sample having a curved surface. The Terahertz signal 36 is reflected and detector by the sensor 30, and measured.

The measured THz radiation is passed to an analysis unit 32 for analysing a measured THz radiation reflected from the sample 34 exposed to a pulse of THz radiation, i.e. a sample response. The analysis unit 32 refers to a reference library 38 to obtain a correction factor. This correction factor is based on a measured curvature of the sample. For the measured curvature, a correction factor is applied to the sample response that provides a corrected reflection. This corrected reflection is then analysed using the process described above to determine the layer thickness.

Whilst the reference library (profile library) 38 is shown as being part of the analysis unit 32, it can also be separate. Likewise, the sensor 30 can house the analysis unit 32 and the emitter and detector parts of the sensor 30 too can be integrated or separate.

The reference library 38 comprises sample responses, e.g. measured reflected THz radiation, from library samples that are otherwise the same as the sample of interest 34.

However, the coating of the library samples is removed or such that the THz wavelength is fully reflected.

As discussed above, in some cases, the library 38 can be compiled from other means, such as from calculation, e.g. theoretical calculations of system response to curvature

In an example, the phase arg (rₚ) and magnitude |rₚ| of the Terahertz reflection rₚ are measured for a series of library samples with a range of profile curvatures p to cover curvatures of all samples of interest that are to be measured to discern their coating layers.

The profile curvature of the library samples is also measured. This curvature is measured by a non-Terahertz means, such as a near infrared laser gauge capable of measuring the profile in reflectivity. The measured phase, magnitude and curvature for each library sample form a profile reference library.

Reference samples have the nominal (midpoint or average) profile curvature (p₀) across the range of curvatures to be corrected. One of the samples to be measured when constructing the profile reference table has the same, nominal curvature (p₀) as the reference.

The ratio of this nominal sample/reference sample gives nominal reflectance r₀, with magnitude and phase |r₀|, arg (r₀), respectively. Layer thickness is calculated from this ratio. Layer thicknesses are then derived using the techniques described with reference to FIG. 4 above and in the prior art.

In some situations, the profile correction could be used if a different thickness method is used.

Error terms are applied to correct for the effect of or profile. Frequency dependent error terms (for phase and magnitude) are calculated (using a polynomial fit or another fitting or extrapolation technique) from each profile reference sample in the profile reference library and the nominal reflectance r₀.

In particular, a magnitude error and phase error are calculated across the Terahertz range as function of frequency f as follows:

Magnitude as a function of frequency:

$$E {M ( f )}_{p} = \frac{\vert {r}_{p} \vert ( f )}{\vert {r}_{0} \vert ( f )} \qquad ( 2 )$$

Phase as a function of frequency:

$$E {P ( f )}_{p} = arg ( {r}_{p} ) ( f ) - arg ( {r}_{0} ) ( f ) \qquad ( 3 )$$

These error terms are generalised for any given profile p by interpolation between discrete profile measurements or by fitting a surface function such that EM(f,p) satisfies EM(f)ₚ for all discrete profiles p.

For a sample with a measured curvature (and hence profile p), the measured reflectivity rₛ with measured profile p can then be corrected using the above error terms. This will provide the corrected magnitude |r|_{c} and corrected phase arg(r)_{c} for the sample i.e. the magnitude and phase of the sample if it had a profile the same as the nominal profile p₀.

$${\vert r \vert}_{c} = \frac{\vert {r}_{s} \vert}{E M ( f , p )} \qquad ( 4 )$$

$${arg ( r )}_{c} = arg ( {r}_{s} ) - E P ( f , p ) \qquad ( 5 )$$

This allows the corrected reflection measurement to be used to calculate the sample thickness without errors caused by variation in the sample profile.

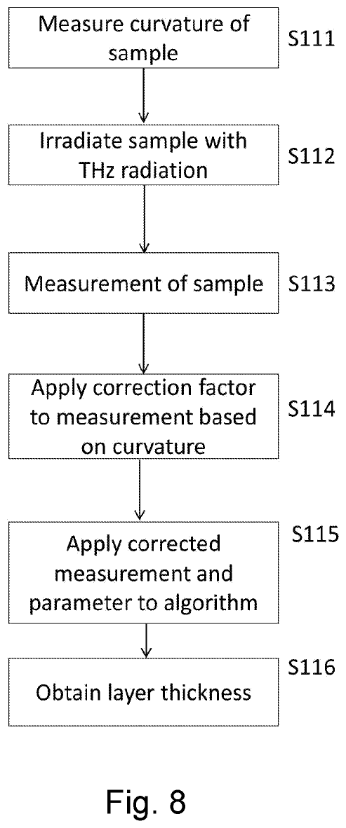

FIG. 8 shows a flowchart of the basic process which is used for determining the thickness of layers in a curved sample.

In step S111, the curvature of a sample is measured. This can be done via various methods, such as using infrared.

In step S112 the sample is irradiated with THz radiation. Terahertz radiation is emitted in a pulse or continuous wave form.

In step S113, the measurements from the sample are taken. The Terahertz is reflected from the sample to the detector. The measurements are in the form of a sample response to the emitted THz radiation. The measurements will include a factor due to the layer thickness and due to the curvature of the sample.

In step S114, a correction factor is applied to the measurement. This is based on the measured curvature and, as discussed above, a profile library can be used to reference the relevant correction factor for the curvature. An algorithm may be used to apply the correction factor, such as equations (4) and (5).

In step S115, any additional parameters, such as refractive index, can be applied with the corrected measurement to an algorithm to calculate the layer thickness measurement. As described above with reference to FIG. 4, this can be by using the time delay as shown in equation (1).

In step S116, the coating thickness is obtained from the previous step.

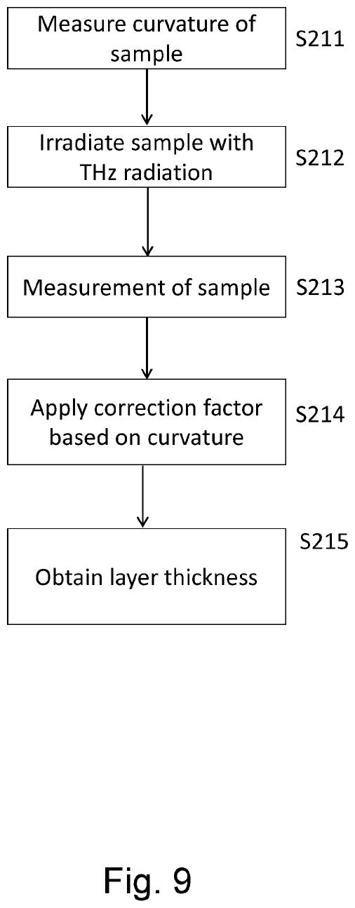

FIG. 9 shows a flowchart of a process which may be used for determining the thickness of layers in a sample of interest.

In step S211, the curvature of a sample of interest is measured.

In step S212, the sample of interest is irradiated with THz radiation.

In step S213, the measurements from the sample of interest are taken. The Terahertz radiation is reflected from the sample of interest to the detector. The reflected radiation is detected, resulting in a time-domain reflected waveform.

A sample response is derived from the reflected radiation. In this example, a Fourier transform is taken of the measured waveform to give a frequency domain representation. A Fourier transform is used to provide a complex frequency spectrum, which comprises a complex value (having real and imaginary components) corresponding to each frequency—this is referred to as the initial complex frequency spectrum. This initial complex frequency spectrum is then divided by a stored first complex frequency spectrum—in this step, for each frequency, the complex value from the initial spectrum is divided by the complex value from the first spectrum. The result is referred to here as the measured complex frequency spectrum, which comprises a complex value corresponding to each frequency in the spectrum.

The first complex frequency spectrum in this example corresponds to a first sample having a substrate having a nominal curvature and a gold coating. The first complex frequency spectrum is generated by performing a Terahertz measurement on this first sample, deriving the sample response, and performing a Fourier transform. The first complex frequency spectrum is thus derived from measured reflected THz radiation from a first sample that is otherwise the same as the sample of interest, but has the nominal curvature and only a gold coating. The first complex frequency spectrum is then stored for use in S213 of the process for determining the thickness for a sample of interest.

In step S214, a correction is applied to the measured complex frequency spectrum output from S213.

The correction is applied using stored information. How the stored information is generated will therefore first be described.

A set of two of more library samples with a range of curvatures is used to generate the stored information. In this example, one of the library samples has the nominal curvature—i.e. the same curvature as the first sample. The nominal curvature also corresponds to the average or mid-point curvature of the library samples. In this example, each library sample has a structure the same as that of the sample of interest. In other words, each library sample has the same substrate and coatings as the sample of interest. The library samples have a range of different curvatures however, including the nominal curvature. In some other examples, the library samples may be uncoated.

A complex frequency spectrum is generated for each of the library samples by performing a Terahertz measurement on the library sample and performing a Fourier transform. Each complex frequency spectrum is then divided by the complex frequency spectrum corresponding to the library sample having the nominal curvature, to give a complex error for the library sample. Thus, the complex Terahertz reflection rₚ is measured for a series of library samples with a range of profile curvatures p to cover curvatures of all samples of interest that are to be measured to discern their coating layers. In particular, the frequency domain representation of the reflection rₚ is generated for a series of library samples with a range of profile curvatures p to cover curvatures of all samples of interest. The frequency domain representation comprises real and imaginary components for each frequency. The complex error is then calculated as function of frequency f across a frequency range covering the plurality of frequencies of the emitted Terahertz radiation as follows:

$$E {C ( f )}_{p} = \frac{{r}_{p} ( f )}{{r}_{0} ( f )} \qquad ( 6 )$$

where rₚ(f) is the frequency domain representation of the sample response of the library sample with curvature profile p, and r₀(f) is the frequency domain representation of the sample response of the library sample having the nominal curvature. For each frequency, the complex value from the library sample spectrum is divided by the complex value from the spectrum of the library sample having the nominal curvature. The resulting complex errorEC(f)ₚ, comprises a complex value corresponding to each frequency in the spectrum. Frequency dependent error terms (the real and imaginary components of the complex error) are derived for each library sample.

The set of complex errors EC(f)ₚ for the library samples may be stored and used to apply the correction in S214.

Alternatively, a polynomial fit may be used to smooth the complex errors. A set of complex errors derived from the fit can then be stored in the profile reference library. For example, the complex value of the error may be fit as a function of curvature for each frequency. For each frequency, complex error values may then be derived from this fit for each of a set of curvature values.

The stored information comprises, for each of a set of one or more curvatures, a complex error, in other words a set of complex error values, one for each frequency.

These complex errors can be generalised for any given curvature profile of a sample of interest by interpolation between the complex errors. Thus in S214, the complex error for the curvature profile of the sample of interest can be derived by, for example, linear interpolation between the two closest sample curvatures either side of the sample of interest in the library.

This derived complex error is then applied to correct for the effect of the curvature on the measured reflection from the sample of interest. Error terms, in this case the real and imaginary components of the derived complex error, are applied to correct for the effect of the profile on the measured reflection from the sample of interest.

For a sample of interest with a measured curvature (and hence profile p), the measured complex reflectance rₛ with measured profile p is corrected using the above complex error. This will provide the corrected complex reflectance for the sample i.e. the complex reflectance of the sample if it had a profile the same as the nominal profile p₀. In this step, the complex frequency spectrum output from S213, is corrected using the complex error terms. This will provide the corrected frequency domain representation of the sample response i.e. the frequency domain representation of the sample response if it had a profile the same as the nominal profile p₀. Hence, for a sample of interest with the nominal curvature profile, the correction term would be 1 (i.e. no curvature correction). The correction is performed by dividing the measured complex frequency spectrum by the derived complex error.

$${r}_{c} = \frac{{r}_{s}}{E C ( f , p )} \qquad ( 7 )$$

wherein rₛ is the complex sample reflectance, in this example corresponding to the measured complex frequency spectrum output from S213, and EC(f,p) is the derived complex error for the profile of the sample of interest. This allows the corrected reflection measurement to be used to calculate the sample thickness without errors caused by variation in the sample profile.

An inverse Fourier transform is applied to the corrected complex frequency spectrum r_{c} to give a corrected sample response—a time domain waveform.

In step S215, any additional parameters, such as refractive index, can be applied with the corrected sample response to an algorithm to calculate the layer thickness. As described above with reference to FIG. 4, this can be by using the time delay as shown in equation (1). The time delay of the reflected pulse as it passes through the layers is used to determine a thickness of the layer using a refractive index of said layer, as for instance, in GB 2559164 A, the entire contents of which are incorporated by reference herein. A preferred refractive index value or model may be selected from data from a set of calibration samples. For instance, the set of calibration samples may be samples with a substrate and a single coating layer or/and a plurality of coating layers, and the nominal curvature profile p₀.

The above embodiments address the problem of compensating for the curvature of the surface in Terahertz determinations by using a correction factor based on curvatures of a profile library compared to a nominal profile. Therefore, the corrected measurement is the equivalent of a sample with a nominal profile and the layer thickness can be calculated.

1. A method for determining the thickness of a plurality of coating layers on a curved surface of a sample, the method comprising:
measuring a curvature of the sample,
irradiating the said sample with THz radiation, said THz radiation comprising a plurality of frequencies in the range from 0.01 THz to 10 THz;
detecting the reflected radiation to produce a sample response said sample response being derived from the reflected radiation;
referring to a profile library containing at least one profile library sample to obtain a correction factor based on the curvature of the sample;
applying the correction factor to the sample response to obtain a corrected reflection;
outputting the thicknesses of the layers using the corrected reflection.

2. A method according to claim 1, wherein the at least one profile library sample having a curvature similar to the sample.

3. A method according to claim 1, wherein there is provided the plurality of profile library samples forming a range of curvatures, the range of curvatures for interpolation or extrapolation to obtain a resultant curvature, the resultant curvature being similar to the sample.

4. A method according to claim 1, wherein the correction factor is obtained from the comparison of the parameters of the profile library samples to the parameters of a nominal profile library sample.

5. A method according to claim 1, where the profile library samples have a structure the same as that of said sample.

6. A method according to claim 1, wherein the profile library contains the magnitude and phase of the waveform for reflected radiation for the profile library samples.

7. A method according to claim 6, wherein a magnitude error and a phase error is calculated as a function of frequency across the 0.01 THz to 10 THz range, wherein the correction factor is interpolated for the measured curvature of the sample.

8. A method according to claim 7, wherein magnitude error and phase error are calculated using a polynomial fit for each profile library sample.

9. A method according to claim 1, wherein a profile is measured using the curvature that is a single value parameter.

10. A method according to claim 1, wherein the library profile samples are uncoated.

11. A method according to claim 1, wherein the library profile samples are coated with a highly reflective layer.

12. A method according to claim 1, wherein a time delay of detecting the reflected radiation is measured for outputting the thickness of the layers.

13. A method according to claim 1, wherein a refractive index for each of the plurality of layers is used for outputting the thickness of the layers.

14. A method according to claim 13, including selecting a preferred refractive index value or model from data from a set of calibration samples.

15. A method according to claim 1, wherein the curvature is measured using a laser gauge.

16. A system for determining the thickness of a plurality of coating layers on a curved surface of a sample, the system comprising:
a sensor, said sensor comprising a source of THz radiation for irradiating the said sample with THz radiation in a plurality of frequencies in the range from 0.01 THz to 10 THz;
a detector for detecting the reflected radiation to produce a sample response said sample response being derived from the reflected radiation;
the system further comprising an analysis unit, said analysis unit comprising a processor and a memory, said processor being adapted to:
access a profile library containing at least one profile library sample to obtain a correction factor based on a measured curvature of the sample;
apply the correction factor to the sample response to obtain a corrected reflection;
calculate the thicknesses of the layers using the corrected reflection.
